(19) United States
(12) Patent Application Publication
(10) Pub. No.: US 2016/0150736 A1
(43) Pub. Date: Jun. 2, 2016

(54) PROCESSOR FOR FEED AND DEBRIS

(71) Applicant: Patz Corporation, Pound, WI (US)

(72) Inventors: Anthony H. Sailer, Pound, WI (US); Brad Bedord, Crivitz, WI (US)

(73) Assignee: PATZ CORPORATION, Pound, WI (US)

(21) Appl. No.: 14/736,737

(22) Filed: Jun. 11, 2015

Related U.S. Application Data
(60) Provisional application No. 62/010,566, filed on Jun. 11, 2014.

(51) Int. Cl. A01F 29/00

(52) U.S. Cl. CPC A01F 29/005

(57) ABSTRACT

A processor for use with a mixer, which includes a processor frame, mounted to the mixer tub, and a plurality of rotatable shafts, rotatably mounted to the processor frame. A plurality of processing elements is affixed to each of the rotatable shafts. A prime mover is connected to and drives at least one of the rotatable shafts, and at least one other rotatable shaft is rotated by being connected to the first rotatable shaft connected to the prime mover. Some of the processing elements on adjacent rotatable shafts overlap, and others do not. A structure may be provided to control the amount of contact between the processing elements and a material to be processed, which may include a grating above the rotatable shafts, and apparatus for raising and lowering the grating with respect to the processing elements.

### CROSS REFERENCE TO RELATED APPLICATION

This application claims the benefit of U.S. Provisional Patent Application Ser. No. 62/010,566, filed Jun. 11, 2014. All information disclosed in that application is incorporated herein by reference.

### FIELD OF THE INVENTION

The present invention relates generally to processing equipment for feed and debris, and in particular, to machines for processing large volumes of hay for animal feed, or debris for composting.

### BACKGROUND

A common type of agricultural equipment is a vertical feed mixer, which is generally formed of a large open-topped tub having one or more rotors within the tub, for mixing animal feed before delivering the feed to the animals. The feed is generally added to the tub by means of the open top.

One of the types of animal feed often placed within a mixer is a large bale of hay, generally about five feet long and four feet in diameter, or a large square bale of similar volume and mass. A large bale such as this will often have a rolled and wrapped construction, with long stems of grass, alfalfa and other forage. Accordingly, the process for preparing this material to be fed to cattle includes breaking apart the bale (taking apart the rolled and wrapped construction of the bale), and then reducing the size of the individual materials making up the bale (reducing the size of the material, such as the stems, etc.), for easiest feeding by the cattle. Some operators simply use the rotors in the mixer tub to break up the bale and mix it with the other feed in the feed mixer. This simple use of the rotors alone can be problematic in that it can take time to process a large bale, which can cause undue delays in the feeding process. Using the mixer rotors to process a large bale can also cause undue or premature wear on the feed mixer. Moreover, the weight or amount of hay needed for a particular ration for a particular type of animal may not be met by the volume of hay making up the bale, resulting in the mixer having an unbalanced ration, and unbalanced rations can have suboptimal growth or production effects on the animals, and even adverse health effects. Alternatively, even if the operator realizes that the ration is unbalanced, the operator may have to move to different locations and discharge some of the processed hay in order to get the correct amount in the mixer, and then return to refill the mixer with the other ingredients of the ration, in order to get the correct amount of hay and other ingredients in the ration.

To solve this problem, separate bale processors have been devised. In using a separate bale processor, an operator may process a number of bales, and allow the processed hay to pile up for feeding at a later time. This procedure takes extra time, as well as additional equipment, such as a separate loader or tractor for loading the processed feed into the mixer, with attendant waste of the now smaller particles, and generally increased handling, besides the cost of the separate hay processor itself

Further, there are times when materials other than feed need to be processed. For instance, yard waste can be processed for use as compost, by use of a compost mixer.

This invention relates to improvements to some of the apparatus described above, and to solutions to some of the problems raised or not solved thereby.

### SUMMARY OF THE INVENTION

The invention provides a processor for use with a mixer having a tub. The processor includes a processor frame, mounted to the mixer tub, and a plurality of shafts, rotatably mounted to the processor frame. A plurality of processing elements is affixed to each of the rotatable shafts. A prime mover rotates the rotatable shafts, which prime mover is connected to and drives at least one of the rotatable shafts, and wherein at least one other rotatable shaft is rotated by being connected to the first rotatable shaft connected to the prime mover. At least some of the processing elements on adjacent rotatable shafts may overlap, whereas others might not. The invention may also provide a structure for controlling the amount of contact between the processing elements and a material to be processed, which structure may include a grating positioned above the rotatable shafts, and means for raising and lowering the grating with respect to the processing elements. The means for raising and lowering may include a hydraulic cylinder for extending and retracting the grating over the processing elements.

Other objects and advantages of the invention will become apparent hereinafter.

### DESCRIPTION OF THE DRAWING

FIG. 1 is an upper isometric view of a mixer with a processing apparatus mounted thereon, according to one embodiment of the invention.

FIG. 2 is an upper isometric view of a mixer with the processing apparatus mounted thereon, according to another embodiment of the invention.

FIG. 3 is an end view of the mixer and processing apparatus shown in FIG. 1, with the addition of a round bale on the processing apparatus.

FIG. 4 a top view of the mixer and processing apparatus shown in FIG. 3.

FIG. 5 is an enlarged view of a portion of the top view shown in FIG. 4, showing additional detail.

FIG. 6 is a side view of a mixer and processing apparatus constructed according to another embodiment of the invention.

FIG. 7 is a side view of the mixer and processing apparatus shown in FIG. 6, with the processing apparatus in a partially raised position.

FIG. 8 is an upper isometric view of the mixer and processing apparatus shown in FIG. 6.

FIG. 9 is an enlarged view of a portion of the side view shown in FIG. 7, showing additional detail.

FIG. 10 is a front elevation view of a mixer and processor constructed according to another embodiment of the invention.

FIG. 11 is a side elevation view of the mixer and processor shown in FIG. 10.

FIG. 12 is a front elevation view of the mixer and processor shown in FIG. 10.

FIG. 13 is an isometric view of the mixer and processor shown in FIG. 10.

FIG. 14 is a top plan view of a mixer and processor constructed according to another embodiment of the invention.

FIG. 15 is a front elevation view of the mixer and processor shown in FIG. 14.

FIG. 16 is a side elevation view of the mixer and processor shown in FIG. 14.

FIG. 17 is an isometric view of the mixer and processor shown in FIG. 14.

### DETAILED DESCRIPTION

Even though the following description refers mainly to feed mixers, the term “mixer” as used herein can be applied equally well to a feed mixer for processing livestock feed such as hay bales, and to a compost mixer for processing yard waste or similar materials.

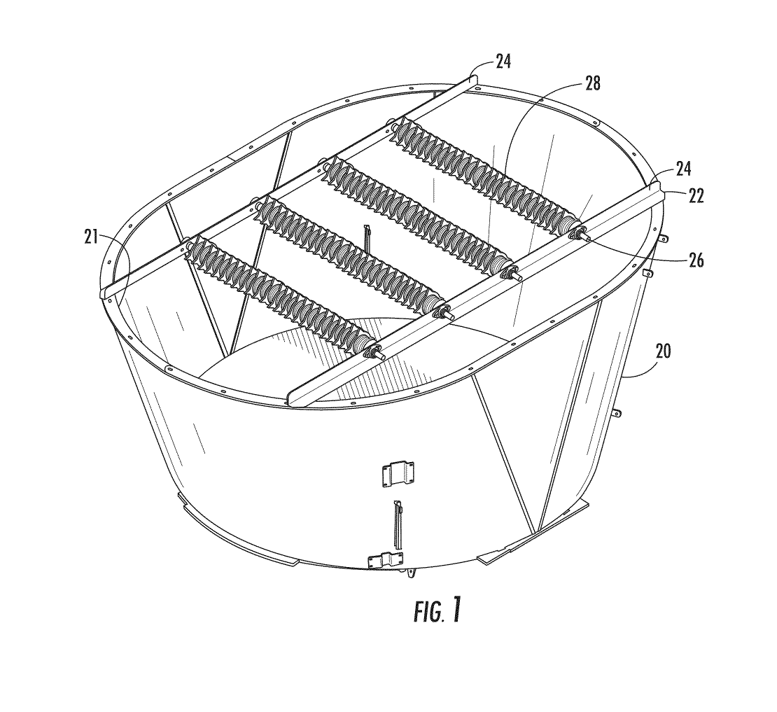

One aspect of the present invention provides a feed mixer having hay bale processing features integrated with the feed mixer. FIG. 1 shows a feed mixer 20 having a tub 21 and a processor 22 mounted to the top of the tub. The processor 22 includes a processor frame including at least a pair of supports 24 which run the length of and are attached to the elliptical upper opening of the tub 21. The processor 22 further includes a plurality of rotatable shafts 26 rotatably mounted to the supports 24. Four such rotatable shafts 26 are shown in the embodiment illustrated in FIG. 1, although other numbers of such rotatable shafts are possible. Each of the rotatable shafts 26 has a series of cutting/ripping/tearing/grinding/crushing/shearing elements 28, also referred to as processing elements, affixed thereon. Various processing elements could be used, including the Patz Quadra-Shark blade as shown at http://patzcorp.com/success-stories/choppers-2/hay-bales/model-9427-success-story-proven-chopping-performance/, or other processing elements such as hammers, cutters, rollers, knives, disks, etc.

FIG. 2 shows an alternative embodiment of the invention, wherein a processor 122 is mounted in a direction transverse to that shown in FIG. 1, that is, across the width of the elliptical upper opening of the tub 21 of the feed mixer 20. The processor 122 in FIG. 2 includes a pair of supports 124, extending across the width of, and attached to, the top edge of the mixer tub 21. A group of rotatable shafts 126 are rotatably mounted to the supports 124. A number of processing elements 128 are attached to each of the rotatable shafts 126.

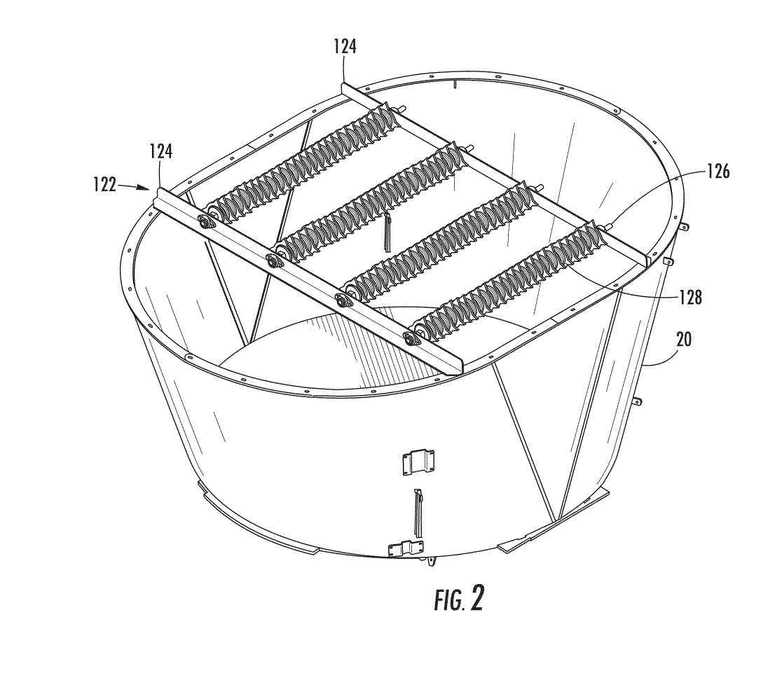

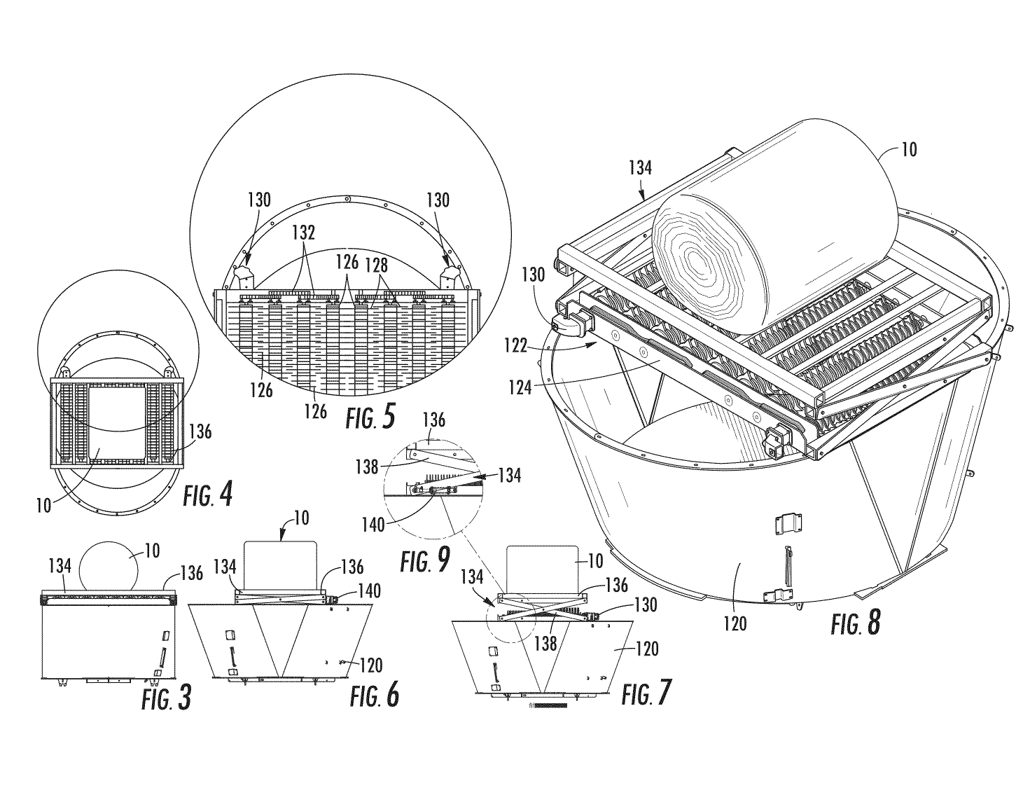

FIG. 3 is an end view of the mixer shown in FIG. 1, with the addition of a round bale 10 applied to the processor 22. FIG. 4 is a top view of the arrangement shown in FIG. 3. And FIG. 5 shows a detail view of an enlarged portion of FIG. 4. As shown there, the rotatable shafts 126 may be driven by any suitable prime movers, including pneumatic actuators, electric motors, gasoline or diesel engines, or hydraulic motors 130 shown in FIG. 5. In the embodiment shown, some of the shafts 126 are driven by hydraulic motors 130, and some of the other shafts 126 are driven by roller chains 132, taking power off of the shafts that are driven by the hydraulic motors. Alternatively, each of the shafts 126 could be driven separately by a distinct hydraulic motor 132 or other prime mover.

While any rotation scheme could be used, one rotation scheme would be for each alternative shaft 126 to rotate in a direction opposite to each adjacent rotatable shaft. This scheme could be accomplished by any suitable arrangement such as driving each alternative shaft 126 by an opposite hydraulic motor 130, or by use of suitable gearing. In addition, the shafts 126 could be rotated in a particular direction for a time, and then the direction of rotation of each of the shafts be reversed for a time.

In certain embodiments, as also shown in FIG. 5, the blades or processing elements 128 could be long enough, in terms of radius from their respective shafts 126, that they reach more than half way toward the adjacent shafts, in which case the processing elements would overlap with each other. Alternatively, the processing elements 128 could be short enough that they do not reach as far as half way toward the adjacent shaft 126, in which case the processing elements would not overlap with each other. Different radii lengths of processing element 128 could be used in different areas of the processor 22 so that the processing elements would overlap in some areas and not overlap in others.

FIGS. 6, 7, 8 and 9, and to an extent FIGS. 3 and 4, show another alternative embodiment of the invention. In this embodiment a mixer 120 includes a processor 122 that is augmented with a lift structure 134 permitting control of the amount of contact and/or pressure that occurs between the bale 10 and the processing elements 128. While various different structures could be used, the lift structure 134 shown includes a grating 136 positioned above the rotatable shafts 126. Lift structure 134 has the capability of raising and lowering the grating 136 by any suitable means, including a scissors structure 138 as shown in FIG. 7, and in more detail in FIG. 9. The raising and lowering means may be actuated by any suitable prime mover, such as one or more linear actuators, electric motors, pneumatic cylinders, or the hydraulic cylinders 140 shown in FIG. 9 to be operating the scissors structure 138. In an alternative usage of this lift structure 134, the grating 136 is raised, and the bale 10 inserted between the grating and the shafts 126. The grating 136 is then lowered to apply downward pressure to the bale 10 toward the shafts 126 and processing elements 128. This usage would be employed where the operator is concerned that the bale 10 may not be efficiently processed by use of gravity alone.

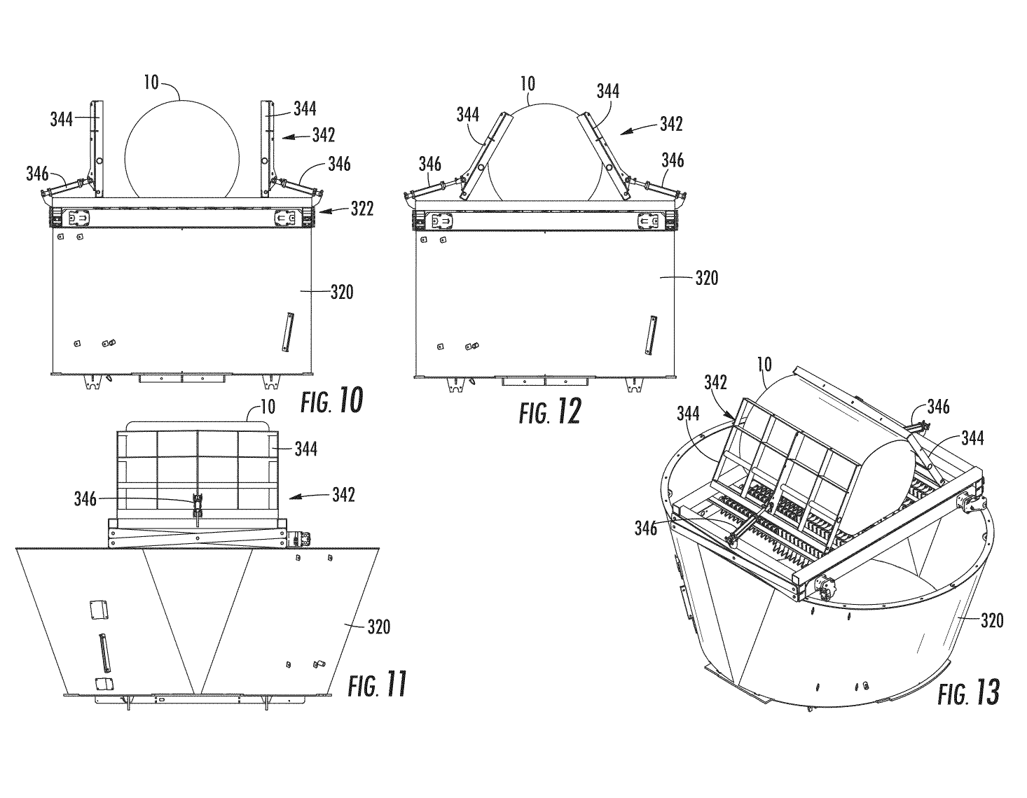

An alternative embodiment of the invention is shown in FIGS. 10, 11, 12 and 13. As there shown, a mixer 320 includes a processor 322, substantially the same as processors 22 and 122 described above. In this embodiment, the mixer 322 includes a pressure device 342 providing a certain amount of extra downward pressure, in addition to gravity, to bring about engagement between the bale 10 and the processor 322. As shown in the figures, pressure device 342 includes a pair of opposing pressure panels 344 hinged to the processor 322. The pressure device 342 further includes rotating structures for causing the pressure panels 344 to rotate toward and away from the bale 10. As shown in the figures, the rotating structures are hydraulic cylinders 346, although other structures for rotating the pressure panels 344 could also be used. FIG. 10 shows the pressure panels 344 in the open position, where no pressure is being applied. This position would also generally be used when the bale 10 is being inserted. FIGS. 12 and 13 shown the pressure panels 344 in an applied position where pressure is being applied to the bale 10.

The apparatus described herein will process the longer feed stuffs from a large round bale into a size or length that is more digestible to the animal, in a more efficient manner than any prior apparatus. Other types of feed can also be processed.

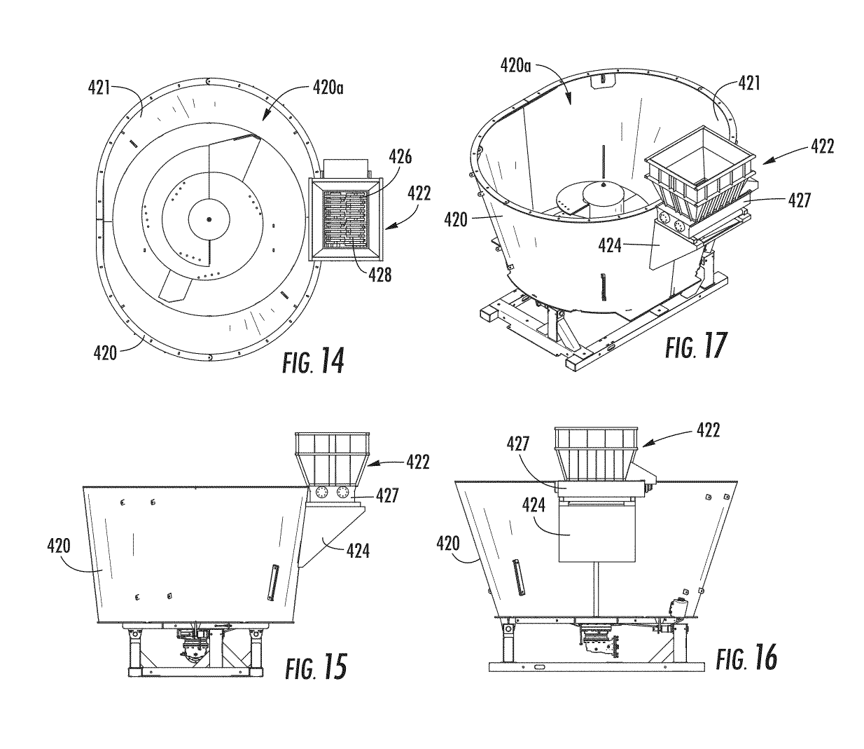

FIGS. 14, 15, 16 and 17 shown another alternative embodiment of the invention. As shown there, a mixer 420 includes a processor 422 for processing smaller amounts of feed, or other items, than large round bale 10. In this embodiment, mixer 420 includes a hopper portion 424 as a part of the mixer tub 421 but optionally constituting a separate opening, permitting the addition into mixer 420 of materials to be mixed by a way other than the large top opening 420a. Similar to the other processors described above, processor 422 includes a group of rotatable shafts 426 are rotatably mounted to a support 427 within the processor. A number of processing elements 428 are attached to each of the rotatable shafts 426, which act to process any materials placed in the processor.

In even more general terms, the apparatus described herein may be used to process source materials into a size or length that is more suitable for a particular application, in a more efficient manner than any prior apparatus. For instance, in another aspect of the invention, the processor can be used as part of a compost mixer to process different kinds of materials, including but not limited to bio-solids, paper waste and yard waste. Such an improved compost mixer would also be useful in decreasing processing cycle time in bio-digesters or incinerators. Bio-solids can include materials that may not be suitable to be fed to animals, such as corn stalks, straw, brush, mortalities and other waste products.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A processor for use with a mixer, the mixer having a tub, the processor comprising:
a processor frame, mounted to the mixer tub;
a plurality of rotatable shafts, rotatably mounted to the processor frame; and
a plurality of processing elements affixed to each of the rotatable shafts.

2. A processor as recited in claim 1 further comprising a prime mover for rotating the rotatable shafts.

3. A processor as recited in claim 2 wherein the prime mover is connected to and drives at least one rotatable shaft, and wherein at least one other shaft is rotated by being connected to the at least one rotatable shaft connected to the prime mover.

4. A processor as recited in claim 3 wherein each rotatable shaft is separated from a nearest adjacent rotatable shaft by a separation distance, wherein each processing element has a maximum dimension extending away from the rotatable shaft to which it is affixed, and wherein the maximum dimension of at least some of the processing elements exceeds half of the separation distance, such that processing elements on adjacent rotatable shafts overlap.

5. A processor as recited in claim 3 wherein each rotatable shaft is separated from a nearest adjacent rotatable shaft by a separation distance, wherein each processing element has a maximum dimension extending away from the rotatable shaft to which it is affixed, and wherein the maximum dimension of at least some of the processing elements is less than half of the separation distance, such that processing elements on adjacent rotatable shafts do not overlap.

6. A processor as recited in claim 1 further comprising a structure for controlling the amount of contact between the processing elements and a material to be processed.

7. A processor as recited in claim 6 wherein the structure includes a grating positioned above the rotatable shafts, and means for raising and lowering the grating with respect to the processing elements.

8. A processor as recited in claim 7 wherein the means for raising and lowering includes a scissors-type structure, and a hydraulic cylinder for extending and retracting the scissors structure over the processing elements.

9. A processing mixer, comprising:
a tub;
a processor frame, mounted to the mixer tub;
a plurality of rotatable shafts, rotatably mounted to the processor frame; and
a plurality of processing elements affixed to each of the rotatable shafts.

10. A processing mixer as recited in claim 9 further comprising a prime mover for rotating the rotatable shafts.

11. A processor as recited in claim 10 wherein the prime mover is connected to and drives at least one rotatable shaft, and wherein at least one other shaft is rotated by being connected to the at least one rotatable shaft connected to the prime mover.

12. A processor as recited in claim 11 wherein each rotatable shaft is separated from a nearest adjacent rotatable shaft by a separation distance, wherein each processing element has a maximum dimension extending away from the rotatable shaft to which it is affixed, and wherein the maximum dimension of at least some of the processing elements exceeds half of the separation distance, such that processing elements on adjacent rotatable shafts overlap.

13. A processor as recited in claim 12 wherein each rotatable shaft is separated from a nearest adjacent rotatable shaft by a separation distance, wherein each processing element has a maximum dimension extending away from the rotatable shaft to which it is affixed, and wherein the maximum dimension of at least some of the processing elements is less than half of the separation distance, such that processing elements on adjacent rotatable shafts do not overlap.

14. A processor as recited in claim 9 further comprising a structure for controlling the amount of contact between the processing elements and a material to be processed.

15. A processor as recited in claim 14 wherein the structure includes a grating positioned above the rotatable shafts, and means for raising and lowering the grating with respect to the processing elements.

16. A processor as recited in claim 15 wherein the means for raising and lowering includes a scissors-type structure, and a hydraulic cylinder for extending and retracting the scissors structure over the processing elements.

17. A processor comprising:
a processor frame, mounted to a mixer tub;
a plurality of rotatable shafts, rotatably mounted to the processor frame;
a plurality of processing elements affixed to each of the rotatable shafts
a prime mover for rotating the rotatable shafts, wherein the prime mover is connected to and drives at least one rotatable shaft, and wherein at least one other shaft is rotated by being connected to the at least one rotatable shaft connected to the prime mover, each rotatable shaft being separated from a nearest adjacent rotatable shaft by a separation distance, wherein each processing element has a maximum dimension extending away from the rotatable shaft to which it is affixed, and wherein the maximum dimension of at least some of the processing elements exceeds half of the separation distance, such that processing elements on adjacent rotatable shafts overlap, and wherein the maximum dimension of at least some of the processing elements is less than half of the separation distance, such that processing elements on adjacent rotatable shafts do not overlap.

18. A processor as recited in claim 17 further comprising a structure for controlling the amount of contact between the processing elements and a material to be processed.

19. A processor as recited in claim 18 wherein the structure includes a grating positioned above the rotatable shafts, and means for raising and lowering the grating with respect to the processing elements.

20. A processor as recited in claim 19 wherein the means for raising and lowering includes a scissors-type structure, and a hydraulic cylinder for extending and retracting the scissors structure over the processing elements.
